(19) United States
(12) Patent Application Publication
(10) Pub. No.: US 2005/0184268 A1
(43) Pub. Date: Aug. 25, 2005

(54) Laser welded butterfly valve blade

(75) Inventors: Karthikeyan R. Narayanaswamy, Canton, MI (US); Bruce J. Harvey, Shelby Township, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive, Inc., Chatham (CA)

(21) Appl. No.: 11/057,579

(22) Filed: Feb. 14, 2005

Related U.S. Application Data
(60) Provisional application No. 60/547,688, filed on Feb. 25, 2004.

(51) Int. Cl. F16K 1/22; B23K 1/20; B21D 51/16

(52) U.S. Cl. 251/308; 29/890.12

(57) ABSTRACT

A butterfly valve blade (16) is attached to a shaft (18) by a laser weld between an inner surface (24) of the butterfly valve blade (16) and the shaft (18). The shaft (18) includes a plastic portion (22) composed of a laser absorbent material. The butterfly valve blade (16) is formed of a laser transparent plastic material. A laser is directed through the butterfly valve blade (16) onto the plastic portion (22) of the shaft (18). Energy form the laser heats the laser absorbent material of the shaft (18) that melts in the presence of the laser. The butterfly valve blade (16) is heated by the heated shaft (18) to melt and form the desired weld that secures the butterfly valve blade (16) to the shaft (18).

### BACKGROUND OF THE INVENTION

The application claims priority to U.S. Provisional Application No. 60/547,688 that was filed on Feb. 25, 2004.

This invention relates generally to a butterfly valve blade. More particularly, this invention relates to plastic butterfly valve blade attachable to a rotating shaft.

A butterfly valve assembly is utilized to meter airflow through an air passage. One example is a throttle body assembly that utilizes a butterfly valve to meter airflow corresponding with fuel from a fuel injector to provide a desired air/fuel mixture. The butterfly valve blade is commonly attached to a shaft that is rotated to rotate the butterfly valve and thereby vary an opening for airflow.

The butterfly valve blade is typically attached to the shaft by way of fasteners such as screws or rivets. Such fasteners require corresponding openings in the butterfly valve blade and in the shaft. The openings and the fasteners complicate assembly. Disadvantageously, fasteners can come loose and fall into the air passage. Further, a loose butterfly valve blade may allow rotation relative to the shaft, causing an incorrect air/fuel mixture.

Another method of attaching a butterfly valve blade to a shaft is to use an interference fit. Mating features are provided on both the shaft and the butterfly valve blade such that the shaft and butterfly valve blade form a substantially rigid connection. Disadvantageously, assembly of the shaft and butterfly valve blade may require some adjustment that is not provided by the rigid connection. This is compensated for by decreasing part and assembly tolerances that can result in increased costs.

Accordingly, it is desirable to develop a butterfly valve blade that provides an adjustment capability and is easily attachable to a shaft without separate fasteners.

### SUMMARY OF THE INVENTION

An example butterfly valve blade according to this invention is attached to a shaft by a laser weld between mating surfaces.

The butterfly valve blade is fixed to the shaft to prevent relative movement between the shaft and the butterfly valve blade. The shaft or the butterfly valve blade includes a plastic portion composed of a laser absorbent material. The other of the butterfly valve blade and shaft includes a portion formed of a laser transparent plastic material. The butterfly valve blade and the shaft include mating geometric features that provide a desired fit between the shaft and the butterfly valve blade to aid in the welding operation.

In one example of this invention, a laser is directed through the butterfly valve blade onto the plastic portion of the shaft. The laser absorbent material of the shaft absorbs energy from the laser and melts to weld the plastic portion of the shaft to an inner surface of the butterfly valve blade. The laser absorbent material of the plastic portion causes a heat build up that melts the plastic portion. The heat build up in the plastic portion causes a similar heating of the laser transparent material of the butterfly valve blade. The laser transparent material of the butterfly valve blade is thereby heated by the laser absorbent material to create the desired weld and secure the butterfly valve blade to the shaft.

Accordingly, the butterfly valve blade of this invention provides for the securement of a butterfly valve blade to a shaft without fasteners and provides adjustment during assembly.

These and other features of the present invention can be best understood from the following specification and drawings, the following of which is a brief description.

### BRIEF DESCRIPTION OF THE DRAWINGS

FIG. 1 is a cross-sectional view of an example butterfly valve assembly according to this invention.

FIG. 2 is a cross-sectional view of an example butterfly valve according to this invention.

FIG. 3 is a cross-sectional view of another example butterfly valve according to this invention.

FIG. 4 is a cross-sectional view of yet another example butterfly valve according to this invention.

FIG. 5 is a perspective view of the example butterfly valve and shaft according to this invention.

FIG. 6 is a perspective view of another example butterfly valve and shaft according to this invention.

### DETAILED DESCRIPTION OF THE PREFERRED EMBODIMENT

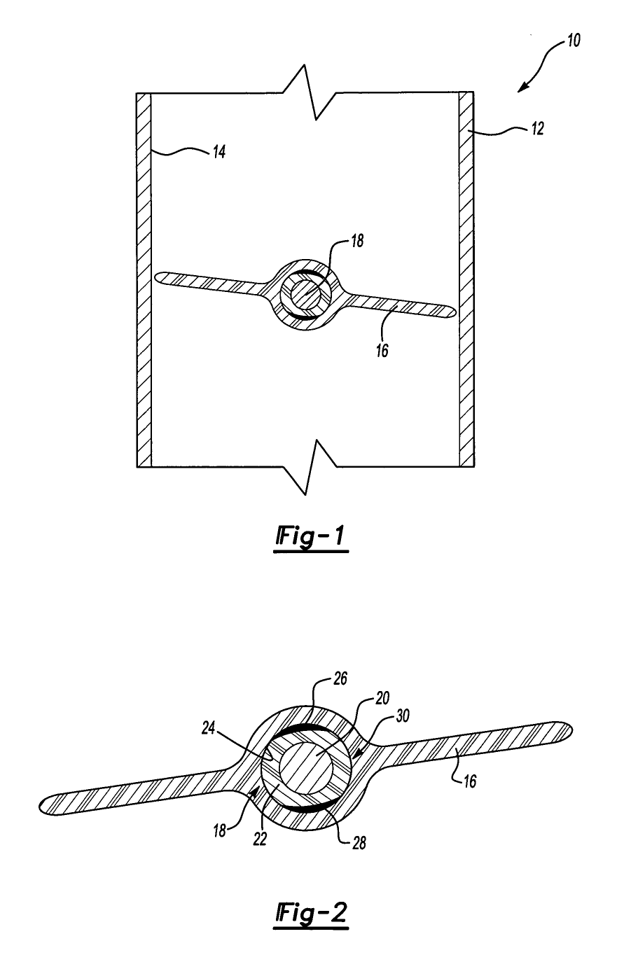

Referring to FIG. 1 a butterfly valve assembly 10 includes a body 12 defining an air passage 14 and a butterfly valve blade 16. A shaft 18 supports the butterfly valve blade 16 and rotates to selectively block airflow through the air passage 14. The butterfly valve blade 16 is fixed to the shaft 18 to prevent relative movement between the shaft 18 and the butterfly valve blade 16.

Referring to FIG. 2, the shaft 18 includes a metal portion 20 and a plastic portion 22. The example butterfly valve blade 16 is formed of a plastic material that is substantially transparent to a laser. A laser transparent plastic material allows enough laser energy to be transmitted though the material for welding. The plastic portion 22 of the shaft 18 is a formed from a material that absorbs energy from the laser and converts that energy into heat in a localized area. The heating of the localized area results in melting of the material to form the desired weld. The butterfly valve blade includes a mating geometry to the shaft. In the example butterfly valve blade 16 the mating geometry includes an opening 30 having an inner surface 24. The shaft 18 is received within the opening 30. The shaft 18 and the butterfly valve blade 16 are placed in direct contact either by an interference fit or by a fixture that holds the two parts together. As appreciated, other mating geometries such as slots and grooved on each of the mating parts are also within the contemplation of this invention. Contact between the shaft 18 and the inner surface 24 of the butterfly valve blade 16 provides for the desired and efficient transfer of laser energy from the laser transparent material to the laser absorbent material.

A transmission welding operation is utilized that directs laser energy through the butterfly valve blade 16 onto the plastic portion 22 of the shaft 18. The laser absorbent material of the shaft 18 melts in the presence of the laser to weld the plastic portion 22 of the shaft to an inner surface 24 of the butterfly valve blade 16. The laser absorbent material of the plastic portion 22 causes a heat build up that melts the plastic portion 22. The heat build up in the plastic portion 22 causes a similar heating of the laser transparent material of the butterfly valve blade 16. The laser transparent material of the butterfly valve blade 16 is thereby heated by the laser absorbent material to create the desired weld and secure the butterfly valve blade 16 to the shaft 18.

The example butterfly valve blade 16 is secured to the shaft 18 by a top weld 26 and a bottom weld 28. The two welds 26, 28 prevent relative movement between the butterfly valve blade 16 and the shaft 18. Further, once the butterfly valve blade 16 is welded to the shaft 18, the attachment is substantially rigid, thereby eliminating play therebetween. Contact between the inner surface 24 and the plastic portion 22 provides the desired contact that transfer heat from the laser to the butterfly valve blade 16 providing for the welds 26, 28.

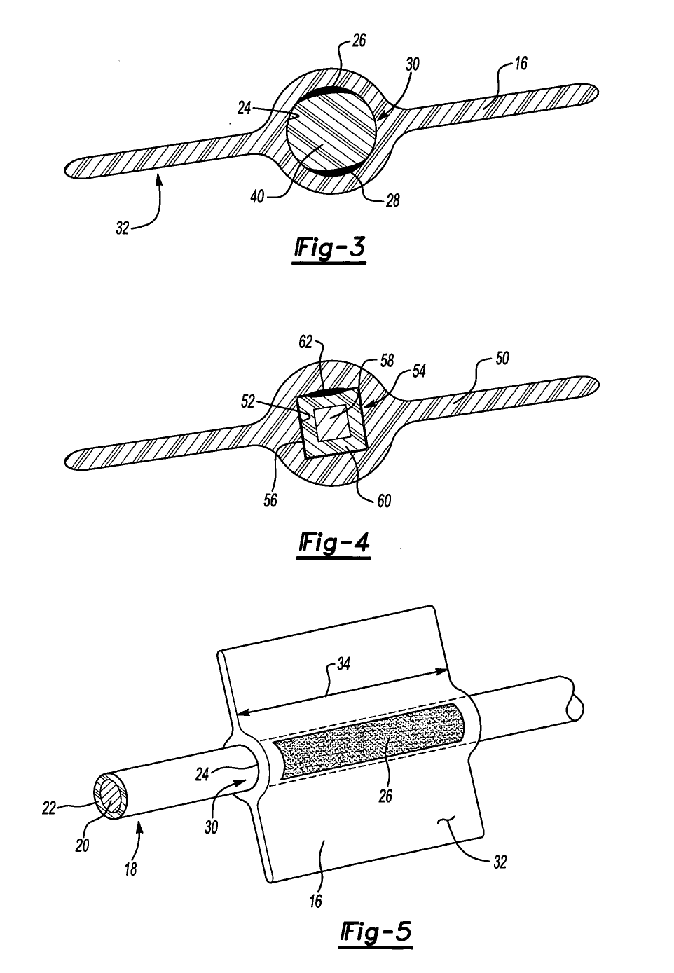

Referring to FIG. 3, the example butterfly valve blade 16 is attached to a shaft 40 that is comprised of a laser absorbent plastic material. The shaft 40 is sized to fit within the opening 30 of the butterfly valve blade 16 such that an outer surface of the shaft 40 is contactable with the inner surface 24 of the butterfly valve blade 16. Contact between the inner surface 24 and the butterfly valve blade 16 can be provided either through a desired interference fit or by way of fixturing for pressing the two parts together.

The shaft 40 absorbs energy from a laser directed through the butterfly valve blade 16. Absorption of the energy from the laser melts the shaft 40 and also heats the inner surface 24 of the butterfly valve blade 16 that also melts to provide the welds 26 and 28. The bond provided by the welds 26, 28 is on the inner surface 24 of the butterfly valve blade 16 and therefore does not produce any discontinuities on an outer surface 32 of the butterfly valve blade 16. Eliminating discontinuities in the butterfly valve blade 16 outer surfaces prevents the formation of any elements that could disrupt the desired airflow.

Referring to FIG. 4, another example butterfly valve blade 50 is shown including an opening 52 having a square shape with an internal surface 54. The opening 52 corresponds to a square shaped shaft 56 having a metal portion 58 and a plastic portion 60. The corresponding square shape of the shaft 56 and the opening 52 provide for positive location of the butterfly valve blade 50. A weld 62 then is performed to secure the butterfly valve blade 50 and prevent any relative movement. As appreciated, although two welds are illustrated in previous examples, a single weld may provide adequate securement for specific applications.

Referring to FIG. 5, the butterfly valve blade 16 is shown having a longitudinal portion 34. The weld 26 is shown as a hidden element between the inner surface 24 of the butterfly valve blade 16 and the shaft 18. The direction and length of the weld 26 provide the desired securement to affix the butterfly valve blade 16 to the shaft 18. As appreciated, although a substantially continuous weld is illustrated, a series of discreetly located welds is also within the contemplation of this invention.

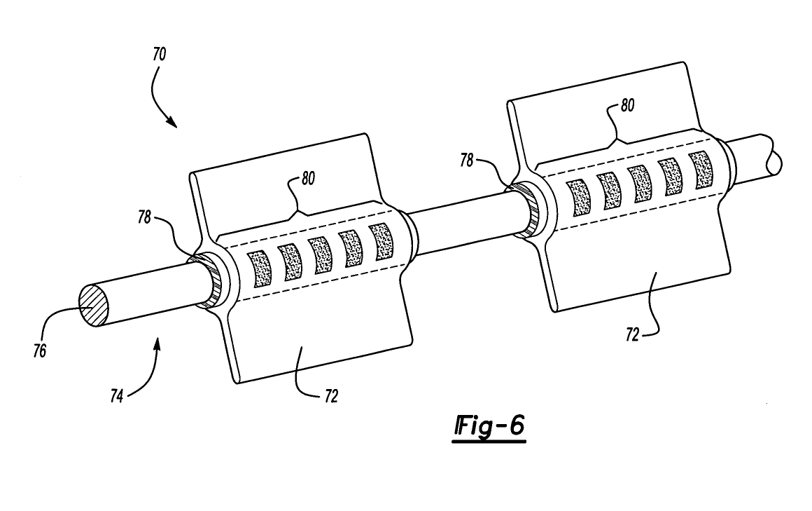

Referring to FIG. 6, an example butterfly valve blade assembly 70 includes two butterfly valve blades 72 spaced apart and attached to a shaft 74. The shaft 74 includes metal portion 76 and plastic portions 78. The plastic portions 78 are spaced apart a distance corresponding to a desired placement of the butterfly valve blades 72. The blades 72 are welded to the butterfly valve shaft 74, and specifically to the plastic portion 78 of the shaft 76. The plastic portion 78 is preferably molded to the metal portion 76 prior to the shaft 74 being inserted into each butterfly valve blade 72.

The plastic portion 78 is a laser absorbent plastic material. The laser absorbent plastic material is a black nylon plastic that absorbs energy transmitted by a laser. The butterfly valve blades 72 are composed of a laser transparent plastic such as a natural nylon. The laser transparent material transmits sufficient laser energy through the butterfly valve blade 72 and form the desired weld. The transparent material does not absorb energy in a localized area and therefore is not heated by the laser to temperatures causing melting of the material. The butterfly valve blade 72 is secured by a series of discreetly placed welds 80. The welds 80 illustrate intermittent weld points for securing the butterfly valve blade 72 to the shaft 74. The size, shape and number of the welds 80 are dependent on each application and may includes square, round or line welds. As the welds 80 occur within the butterfly valve blade 72, the shape of the weld does not harm or change airflow characteristics around and over the butterfly valve blade 72.

The butterfly valve blade of this invention is attached to the shaft by transmission welding operation utilizing a laser weld on an inner surface of the butterfly valve blade. The weld accomplished through the combination of a laser absorbent and laser transparent material. The laser weld method of this invention provides the benefits of a fastener by allowing adjustment during assembly without the possibility of loose parts detrimentally affecting assembly. Further, the laser weld method of this invention provides the benefits of an interference fit while still providing the desired adjustment between parts. The weld provides for a secured butterfly valve blade that will not loosen during use and that simplifies assembly.

Although a preferred embodiment of this invention has been disclosed, a worker of ordinary skill in this art would recognize that certain modifications would come within the scope of this invention. For that reason, the following claims should be studied to determine the true scope and content of this invention.

1. A butterfly valve assembly comprising:
a shaft including one of a laser absorbent medium and a laser transparent medium; and
a butterfly valve blade including another of said laser absorbent medium and said laser transparent medium, wherein said butterfly valve blade is attached to said one of said laser absorbent medium and laser transparent medium included with said shaft.

2. The assembly as recited in claim 1, wherein said shaft comprises a metal shaft portion.

3. The assembly as recited in claim 1, wherein said shaft comprises a plastic shaft formed at least partially with one of said laser absorbent medium and said laser transparent medium.

4. The assembly as recited in claim 1, wherein said butterfly valve blade is welded to said one of said laser absorbent medium and said laser transparent medium included with said shaft.

5. The assembly as recited in claim 1, wherein said laser absorbent medium is a plastic material.

6. The assembly as recited in claim 1, wherein said laser transparent material is a plastic material enabling a portion of laser energy to pass therethrough.

7. The assembly as recited in claim 3, wherein said butterfly valve blade includes a mating feature for receiving said shaft.

8. The assembly as recited in claim 7, wherein said weld is disposed on an inner surface of one of said butterfly valve blade and said shaft.

9. The assembly as recited in claim 7, wherein said mating features extends longitudinally within said butterfly valve blade.

10. The assembly as recited in claim 8, wherein said weld comprises a top weld and a bottom weld spaced circumferentially apart.

11. The assembly as recited in claim 10, wherein each of said top weld and said bottom weld extend longitudinally across said butterfly valve blade.

12. A method of assembling a butterfly valve blade to a shaft comprising the steps of:
a) forming a shaft including one of a laser absorbent material and a laser transparent material;
b) forming a butterfly valve blade including another of the laser absorbent material and said laser transparent material; and
c) welding the butterfly valve blade to the shaft.

13. The method as recited in claim 12 including the step of assembling the shaft to the butterfly valve blade.

14. The method as recited in claim 12 wherein said step c) comprises welding the laser absorbent material on an outer surface of one of the shaft and butterfly valve to an inner surface comprising laser transparent material of the other of the shaft and butterfly valve.

15. The method as recited in claim 12 including the step of encapsulating a metal shaft with the laser absorbent material.

16. The method as recited in claim 15 wherein said butterfly valve includes said laser transparent material and said step c) comprises directing laser energy through the laser transparent material of the butterfly valve to the laser absorbent material encapsulating the metal shaft.

17. The method as recited in claim 16 wherein said step c) comprises welding an outer surface of the shaft to an inner surface of the butterfly valve blade.
